(19) United States
(12) Patent Application Publication
(10) Pub. No.: US 2011/0177747 A1
(43) Pub. Date: Jul. 21, 2011

(54) Method of Making a Fritless Seal in a Ceramic Arc Tube for a Discharge Lamp

(76) Inventors: Thomas Patrician, Monroeton, PA (US); James Avallon, Beverly, MA (US); Victor Perez, Lawrence, MA (US); Walter Lapatovich, Boxford, MA (US); Joanne Browne, Newburyport, MA (US)

(21) Appl. No.: 12/691,038

(22) Filed: Jan. 21, 2010

(51) Int. Cl. H01J 9/26

(52) U.S. Cl. 445/44

(57) ABSTRACT

A method of making a fritless seal in a ceramic arc tube body comprises the steps of: (a) inserting a feedthrough into an opening in a ceramic arc tube body, the feedthrough being comprised of niobium or a niobium alloy; (b) heating the arc tube body to a first temperature in an inert gas to at least partially sinter the arc tube body, the inert gas being selected from the group of argon, neon, krypton, xenon and mixtures thereof; and (c) further sintering the arc tube body by heating to a second temperature in a hydrogen atmosphere to form a hermetic seal between the feedthrough and the ceramic arc tube body, wherein the second temperature is higher than the first temperature.

### TECHNICAL FIELD

This invention relates to arc discharge lamps and more particularly to arc discharge lamps using ceramic arc tubes. Still more particularly, it relates to a method of making ceramic arc tubes utilizing a fritless sintering process for providing an arc tube with hermetic seals and high transmissivity.

### BACKGROUND OF THE INVENTION

Ceramic arc tubes, particularly those constructed of polycrystalline alumina (PCA), have been employed for many years in, for example, high-pressure sodium lamps. More recently, small, bulbous ceramic arc tubes with extended linear capillaries have been used in ceramic metal halide lamps. Sintering and sealing metal electrodes into the latter types of arc tubes have involved multiple steps and the use of sealing frits to achieve hermeticity in these arc tubes. For example, a preferred frit for sealing PCA arc tubes is a Al₂O₃—Dy₂O₃—SiO₂ glass-ceramic material.

Prior arc tubes utilizing fritless seals still have used the elongated capillaries, but have employed molybdenum tubes in a shrink-fit seal. Such arc tubes are functional; however, the thermal coefficients of the ceramic and the molybdenum do not provide an ideal match. Ceramic arc tubes without capillaries are shown in U.S. Patent Application Pub. No. 2009/0058300. In this latter application, frit-less seals are accomplished by means of seal plugs formed from a blend of two or more powdered materials, a process that, while workable, is expensive and time-consuming.

### SUMMARY OF INVENTION

It is, therefore, an object of the invention to obviate the disadvantages of the prior art.

Yet another object of the invention is the improvement of ceramic arc tubes.

These objects are accomplished, in one aspect of the invention, by a method of making a fritless seal in a ceramic arc tube body comprising the steps of:
(a) inserting a feedthrough into an opening in a ceramic arc tube body, the feedthrough being comprised of niobium or a niobium alloy;
(b) heating the arc tube body to a first temperature in an inert gas to at least partially sinter the arc tube body, the inert gas being selected from the group of argon, neon, krypton, xenon and mixtures thereof; and
(c) further sintering the arc tube body by heating to a second temperature in a hydrogen atmosphere to form a hermetic seal between the feedthrough and the ceramic arc tube body, wherein the second temperature is higher than the first temperature.

The partial sintering of the arc tube body at a lower temperature in an inert gas prevents the formation of hydrides in the niobium feedthrough which could make the feedthrough brittle. Completing the sintering at a higher temperature in hydrogen ensures hermeticity between the arc tube body and the niobium feedthrough and a high transmittance level for the fully sintered arc tube.

In one preferred embodiment, prior to the insertion of the feedthrough, the ceramic arc tube body is first formed and treated by the steps of:
(i) molding a mixture of a ceramic material and a removable binder to form the arc tube body, the arc tube body including at least one opening progressing from the exterior of said body to an interior thereof;
(ii) firing the arc tube body at a lower temperature in air to partially remove the binder; and
(iii) pre-sintering the arc tube body at a higher temperature in air to complete the binder removal and strengthen the arc tube body.

### BRIEF DESCRIPTION OF THE DRAWINGS

FIG. 1 is an elevation view, in section, of a first stage arc tube body according to an aspect of the invention;

FIG. 2 is an elevation view, in section, of an arc tube body with feedthroughs inserted;

FIG. 3 is an exploded, elevation view, in section, of the insertion of the final electrode assembly after evacuation and filling;

FIG. 4 is an elevation view, in section of the completed arc tube;

FIG. 5 is a diagrammatic view of a completed arc tube installed in a discharge lamp;

FIGS. 6-8 are elevation views, in section, of yet another embodiment of the invention,

### DETAILED DESCRIPTION THE INVENTION

For a better understanding of the present invention, together with other and further objects, advantages and capabilities thereof, reference is made to the following disclosure and appended claims taken in conjunction with the above-described drawings.

Because of its close compatible thermal expansion properties to PCA, niobium is a highly desirable metal to use in the sealing of arc tubes, whether the arc tube is sealed with a frit or sealed by a direct sealing method during final sintering without use of a frit. Niobium also is a desirable material because of its good weldability characteristics. However, since niobium readily reacts with hydrogen (forming a metal hydride and causing the niobium to become brittle) it is not conducive for use in a direct sealing method during final sintering. Final sintering of a PCA arc tube typically takes place in an atmosphere of hydrogen, which is necessary for proper PCA densification and to obtain the high transmittance required for lamp applications.

U.S. Pat. No. 5,057,048 to Feuersanger describes avoiding the embrittlement of the niobium in a direct sealing method by sintering the niobium/ceramic assembly in a vacuum, or an atmosphere of an inert gas, e.g. argon. The process is described as producing a fritless hermetic seal while maintaining the ductility of the niobium components. However, we have found that this method reduces the transmittance of the ceramic arc tube rendering it opaque in appearance and not well suited for its intended purpose.

To solve the problem of direct sealing niobium to the arc tube without embrittlement of the niobium and while maintaining a high arc tube transmittance, a method was developed whereby in one embodiment the ceramic arc tube/niobium assembly is first at least partially sintered in an inert gas atmosphere, preferably argon, at a first temperature, preferably in a range from about 1000° C. to about 1400° C. The atmosphere of the furnace is then switched over to a hydrogen atmosphere to complete the sintering at a second temperature that is higher than the first temperature, wherein the second temperature is preferably in the range of about 1800° C. to about 1850° C. and is held for about 2 to about 4 hours.

It has been found that when the method of this invention is employed the niobium feedthrough directly seals hermetically to the ceramic arc tube, maintains its ductility and plasticity, and just as important the ceramic arc tube is sintered to a high transmittance. It is believed that the hydride formation in the niobium feedthrough is circumvented by using the argon atmosphere during the low-temperature (1000-1400° C.) sintering phase, while the high transmittance of the arc tube is achieved by the final higher-temperature sintering in hydrogen. It has also been found this method prevents a change in thermal expansion characteristics of the niobium, thereby preventing cracking of the ceramic during final sintering.

In order to illustrate the benefits obtained by using the method of this inventions, two 70 W ceramic arc tube assemblies using niobium tube feedthroughs and PCA arc tube bodies were sintered according to the schedules in Table 1. The Inventive Example was sintered according to the method of this invention whereas the Comparative Example was sintered entirely in an argon atmosphere similar to the method described in U.S. Pat. No. 5,057,048.

TABLE 1

| Inventive Example | Comparative Example |
|---|---|
| Phase 1 - Ar atmosphere | Argon atmosphere throughout the |
| room temp. to 1350° C. | sintering cycle: |
| Phase 2 - dry H₂ atmosphere | Ar atmosphere: room temp. to 1850° C. |
| 1350° C. to 1850° C. | Ar atmosphere: 1850° C. to room temp. |
| Phase 3 - dry H₂ atmosphere | |
| 1850° C. to 1350° C. | |
| Phase 4 - Ar atmosphere | |
| 1350° C. to room temp. | |

TABLE 2

| | Inventive | Comparative | Conventional |
|---|---|---|---|
| Measurement | Example | Example | 70 W arc tube |
| Vickers Hardness of Nb | 213 | 1449 | NA |
| tube (200 g force on the | | | |
| Vickers diamond indenter) | | | |
| Average in-line | 3.51% | 0.58% | 5.49% |
| transmission of | | | |
| ceramic arc tube | | | |

The hardness of the niobium tube feedthroughs and the in-line transmittance of the arc tubes were measured and the results are given in Table 2 above. The hardness of the niobium tube in the Comparative Example was measured to be considerably greater than the measured hardness of the Inventive Example. While it is understood that hardness is not normally a good indicator of brittleness, some tensile regions beneath the indenter do exist because of the dynamics of the hardness test. This phenomenon often results in cracks emanating from the indentation. In this case, cracks were seen around the edges of the indentations in the Comparative Example. Therefore, it can be said that the Comparative Example sintered only in argon was relatively more brittle than the Inventive Example made according to the method of this invention wherein the higher-temperature portion of the sintering cycle was conducted in a dry hydrogen atmosphere.

Just as important, the measured in-line transmittance of the ceramic arc tube of the Inventive Example, 3.51%, is considerably more like the in-line transmittance of a conventionally made ceramic arc tube (sintered in wet hydrogen), 5.49%. The in-line transmittance of the Comparative Example was measured to be only 0.58% and the arc tube exhibited a white opaqueness whereas the Inventive Example had the normal translucent appearance of the conventional arc tube.

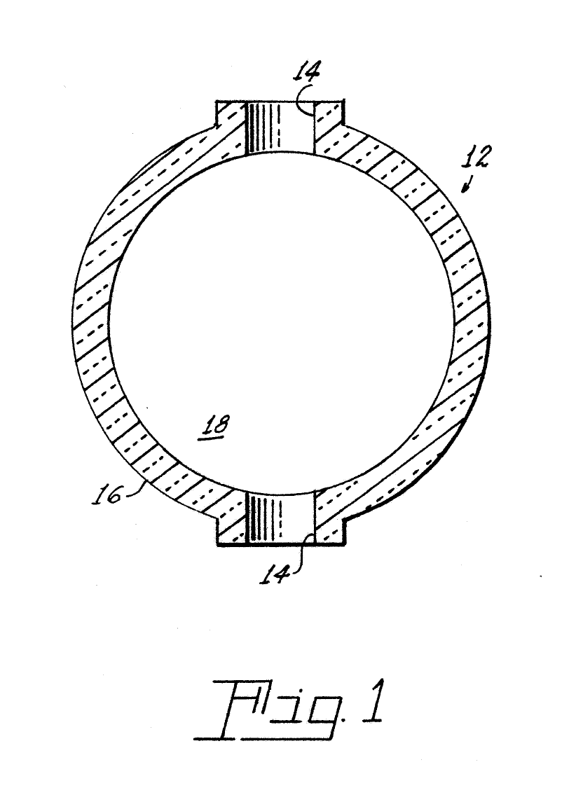

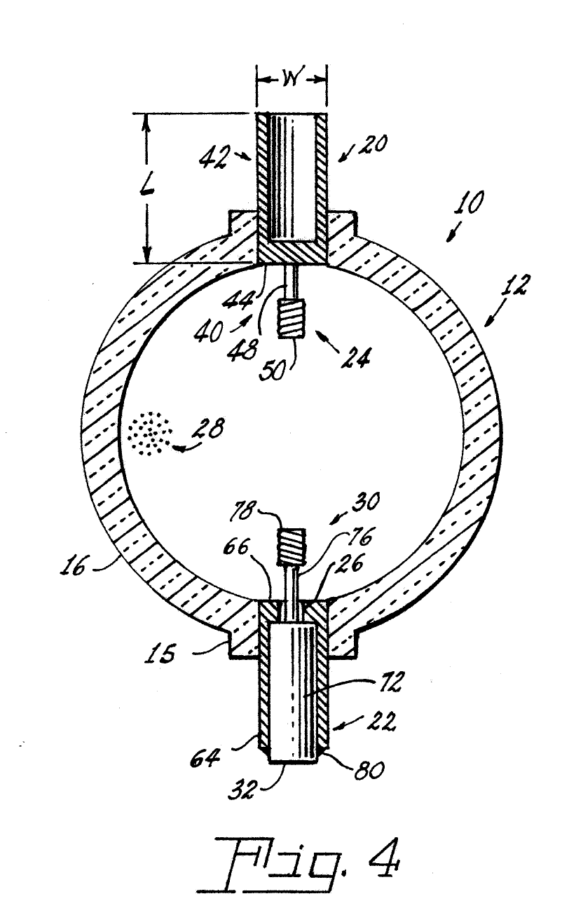

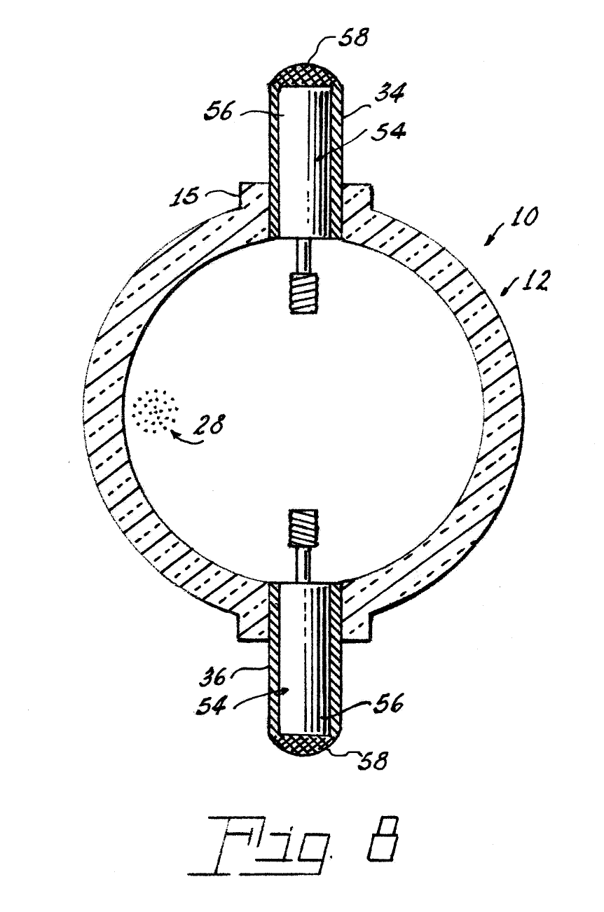

Referring now to the drawings with greater particularity, there is shown in FIG. 1 a first stage ceramic arc discharge body 12 that will be made into an arc tube 10, as shown in FIGS. 4 and 8. The first stage body 12 has an exterior surface 16 and an interior volume 18. At least one and preferably, as shown, two openings 14 progress from the exterior 16 to the interior 18. A boss 15 surrounds the openings 14; however, the boss 15 has a far shorter linear length than the previously used capillaries. Generally, the openings 14 will be diametrically opposed; however, in some instances they can be laterally displaced. The body 12 can be formed from a variety of ceramics such, for example, as polycrystalline alumina, polycrystalline dysprosium, yttria, aluminum oxynitride, aluminum nitride and similar solid metal oxides and metal nitrides and mixtures thereof; however, polycrystalline alumina (PCA) is preferred. For purposes of this disclosure, glass, hard glass and quartz are not considered ceramics.

As shown in the drawings, the shape of the body 12 is spherical; however, this is exemplary only. An important criterion of body shape is an interior configuration that is free of corners. In this regard, shapes such as a prolate sphere, oblate sphere, ellipsoid or similar internally rounded surfaces are equally acceptable. The corner-free surfaces are preferred to avoid cold spots that could form in a corner or other crevice, such as is the case with cylindrical envelopes. Although such rounded body shapes are preferred, the method of this invention applies equally to other arc tube geometries such as cylindrical shapes.

The body 12 has a preferred wall thickness greater than or equal to 0.1 mm and less than or equal to 2.0 mm, with a preferred thickness of about 0.9 mm. Walls can be made of different thicknesses; however, thinner walls decrease the lifetime of lamps employing such arc tubes and thicker walls decrease light transmittance. A preferred interior volume 18 has an internal diameter of greater than 1.0 mm and less than 42.0 mm with a preferred value of 7.9 mm and a preferred volume of about 260 mm³. The openings 14 are about 2.48 mm in diameter.

The first stage body 12 is generally formed by injection molding a mixture of a ceramic material, such as alumina, and a volitalizable binder. The first stage body 12 is fired in air at a temperature of about 100° C. for about 6 hours to partially remove some of the binder and form a second stage (debound) body.

The second stage debound body is then fired in air at about 900° C. for about 2 hours to pre-sinter the body and complete binder removal and form a third stage body.

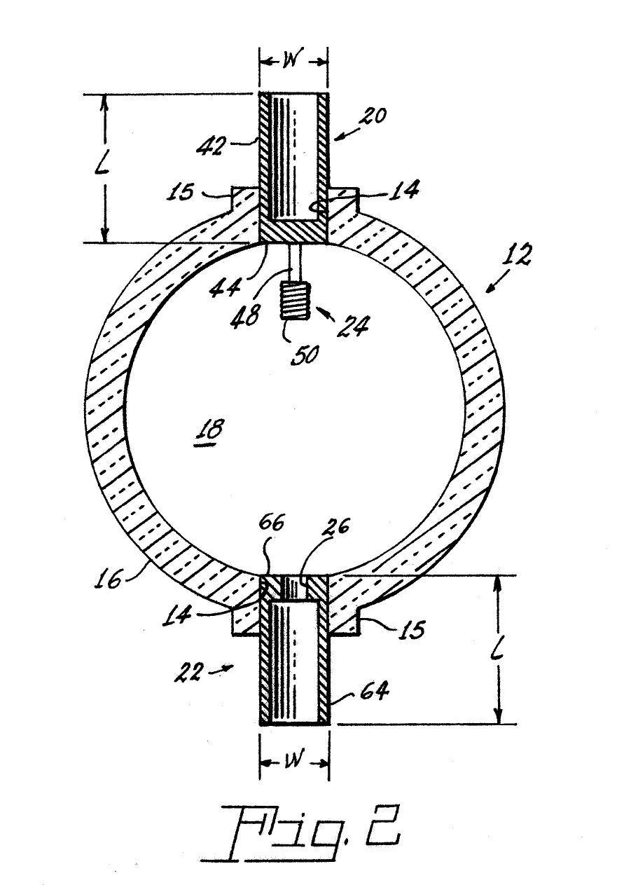

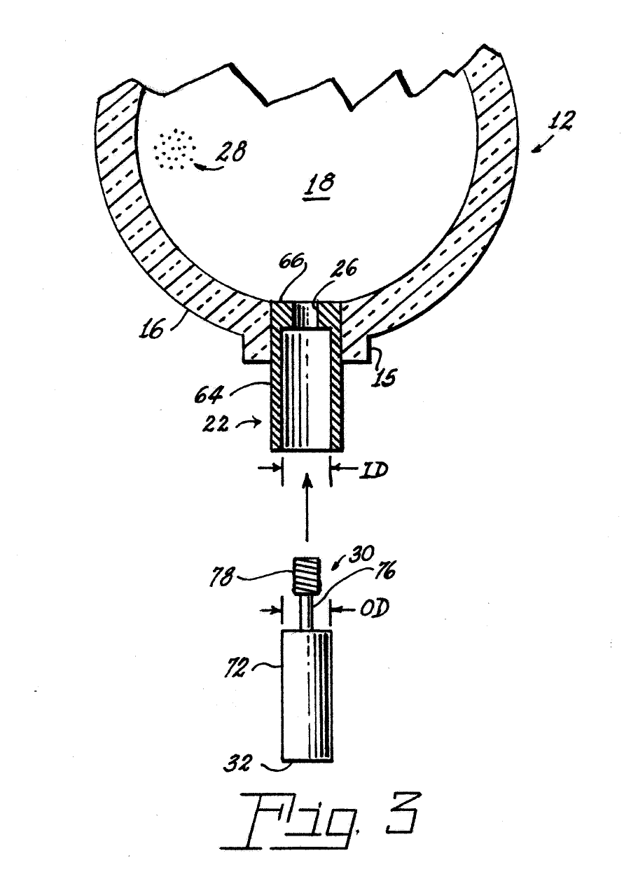

With reference to FIG. 2, feedthroughs 20 and 22 are then inserted into the openings 14 in the second stage debound body 12. In one embodiment of the invention, the first feedthrough 20 has a substantially cup-shaped body 42 with a length L that is longer than its width W, is formed of niobium or a niobium alloy (e.g., niobium containing up to about 2% zirconium by weight), and has a closed end 44 that is substantially planar. An electrode assembly 24 is welded to the closed end 44 of the feedthrough. The electrode assembly 24 is comprised of a tungsten rod 48 that has been overwound with a tungsten coil 50. Niobium feedthrough 20 preferably has a 2.15 mm OD with a 1.65 mm ID and is 6.5 mm in length.

Feedthrough 22 comprises cup-shaped body 64 with similar dimensions to the cup-shaped body 42 and is also comprised of niobium or a niobium alloy. The partially closed end 66 of the cup-shaped body 64 being substantially planar is provided with an aperture 26. The thin walls (˜0.25 mm) of the cup-shaped bodies 42 and 64 provide a more compliant unit than a thick-walled tube or solid piece.

After the niobium feedthroughs 20 and 22 are inserted into the openings 14 (See FIG. 2), the second stage, debound body 12 is fired in an inert atmosphere to at least partially sinter the body 12. The inert atmosphere is selected from argon, neon, krypton, xenon or mixtures thereof; however, argon is preferred. In a preferred embodiment, the body 12 is fired from room temperature (22-25° C.) to 1350° C. in the inert atmosphere at 15° C./min and then further sintered from 1350° C. to 1835° C. in dry hydrogen with a 30 min hold at 1400° C. at 15° C./min, dwelling at 1835° C. for two hours to form the final PCA arc tube body. Concurrent with the densification, the tubular openings 14 of the body 12 shrink onto the niobium feedthroughs 20, 22 forming frit-less hermetic seals.

After final sintering, the body 12 is evacuated and filled with an arc generating and sustaining medium 28. The fill medium can comprise one or more pure metals having a substantial vapor pressure at the operating temperatures that the seal can sustain. The use of the frit-less seals enables the use of fills including pure metals with substantial vaporization temperatures above the typical frit melting temperatures and below the sintering temperatures of the ceramic body material. A preferred fill 28 includes individual pure metals or combinations of pure metals selected from the group including: barium calcium, cesium, indium, lithium, mercury, potassium, sodium, thallium, and zinc. Other pure metals may be used to produce special light sources so long as they do not react with the hermetic seals at the operating temperature. As an example, magnesium may be used but not sulfur, which is expected to form metal sulfides. Further examples may be found in the before-mentioned U.S. Patent Application Publication No. 2009/0058300 A1 (Mar. 5, 2009) which is assigned to the assignee of the instant invention and which is hereby incorporated by reference.

After the filling of the body 12 a second electrode assembly 30 is inserted into the interior 18 of the arc tube body 12 through the aperture 26 in the second niobium feedthrough 22 and an end 32 of the second electrode assembly 30 is sealed to the second niobium feedthrough 22, as by laser welding, to complete the arc discharge tube 10.

The second electrode assembly 30 comprises a cylindrical metallic body 72 with an outside diameter OD substantially matching the inside diameter ID of the cup-shaped body 64 of the feedthrough 22. The cylindrical body 72 which is preferably made of molybdenum is welded to a tungsten rod 76 that is overwound with a tungsten coil 78. The electrode assembly 30 is inserted into the feedthrough 22 and the tungsten coil 78 penetrates the aperture 26 to enter the interior 18 of the arc tube body 12. A weld 80 (FIG. 4) seals the cylindrical body 72 to the cup-shaped body 64.

In a second embodiment of the invention, the arc tube body was made from PCA and had a thermal expansion coefficient of 8.3×10⁻⁶ at 1000° C. The body 12 was formed by injection molding and included a volatilizable binder. After formation the body 12 was fired in air at 100° C. for 6 hours to form a second stage. To complete the binder burn-off and strengthen the arc tube body it is fired at 900° C. in air to form a pre-sintered arc tube body. This pre-sintered body had two diametrically opposed openings 2.48 mm in diameter to shrink seal against two matching niobium feedthroughs 22, having a diameter of 2.15 mm. There is a net shrink fit of 14% during the sintering. The niobium feedthroughs 22 had an ID of 1.65 mm and were 6.5 mm long and a thermal expansion coefficient at 1000° C. of 8.3×10⁻⁶.

A niobium feedthrough 22 was inserted into each opening 14 and the arc tube body was then further sintered from room temperature to 1350° C. in argon and then further sintered from 1350° C. to 1825° C. in dry hydrogen, with a dwell at the final temperature for two hours to form the final arc tube body.

After the completion of the arc tube body 12, an electrode assembly 30 is inserted into one of the feedthroughs 22 and welded in place. The arc tube body is then filled with an arc generating and sustaining medium as before described and a second electrode assembly 30 is inserted into the other feedthrough 22 and welded in place to complete the arc tube.

In a third embodiment of the invention, the steps followed were the same as in the second embodiment, however, the final sintering was carried out at 1850° C. with a dwell at the latter temperature for 4 hours.

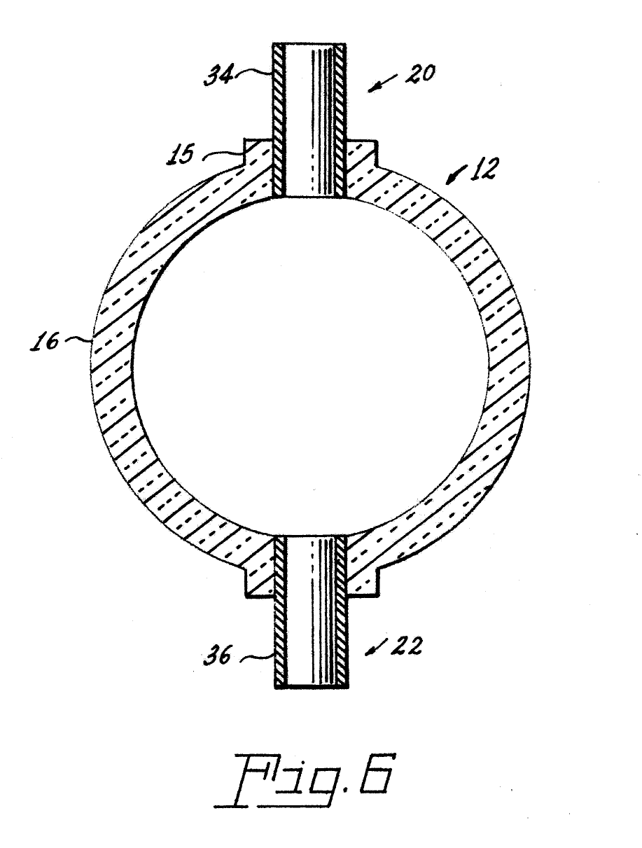

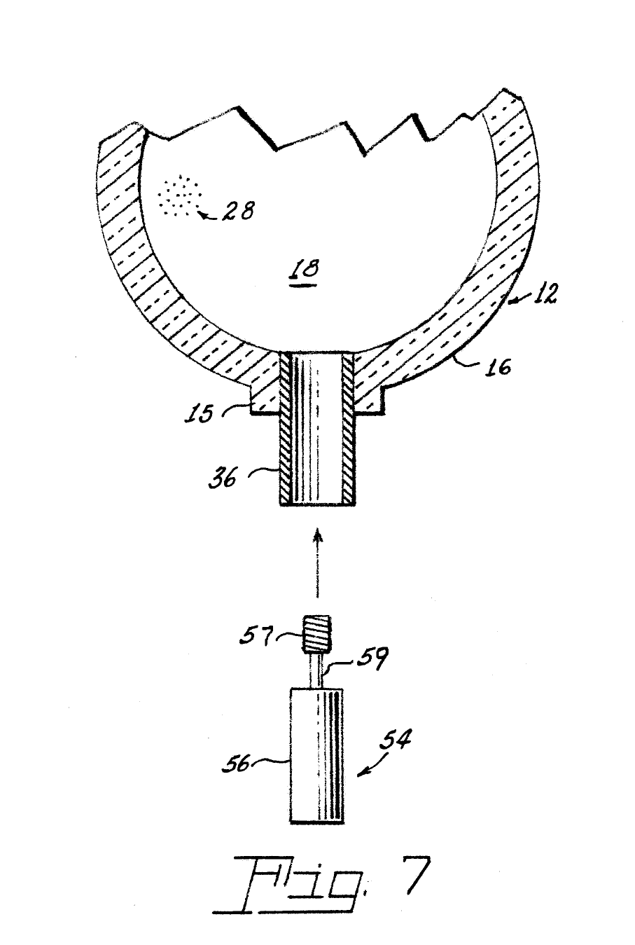

In a fourth embodiment of the invention, illustrated in FIGS. 6-8, the feedthroughs 20, 22 can comprise niobium tubes 34, 36 which, after completion of the arc tube body 12, can be fitted, sequentially, of course, with suitable electrodes. For example, niobium tubes (including niobium tubes with 1 to 2% zirconium) for a particular embodiment of arc tube body size as described above, can have an OD of 1.18 mm and an ID of 0.84 mm. After the arc tube body 12 is completely fired and sintered, an electrode assembly 54, comprised of a molybdenum rod 56 with an OD of 0.82 mm is inserted into the first niobium tube 36 and hermetically welded, as by weld 58, to the outside edge of the niobium tube 36. The electrode assembly 54 further comprises tungsten rod 59 overwound with tungsten coil 57 wherein the tungsten rod 59 is welded to an end of molybdenum rod 56.

After electrode assembly 54 is fixed in position in the first niobium tube 36 the arc tube body 12 is evacuated and filled with the requisite arc generating and sustaining medium 28 and a second similarly configured electrode assembly 54 is inserted into the second niobium tube 34 and hermetically welded thereto to seal and complete the assembly of the ceramic arc tube.

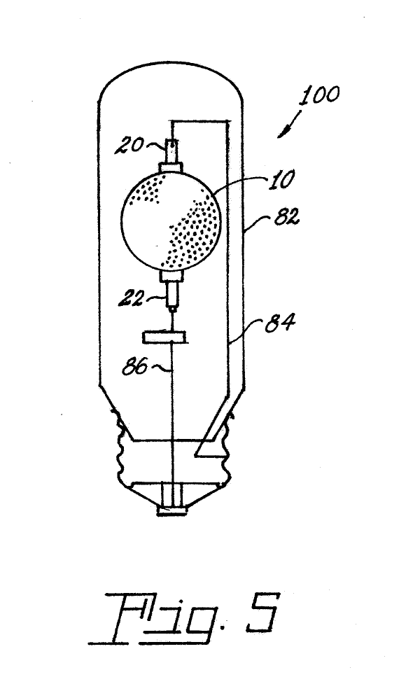

With regard to FIG. 5, an arc discharge lamp 100 can be completed by positioning assembled arc discharge tube 10 formed by any of the embodiment shown herein within an envelope 82 of, for example a suitable glass; and attaching electrical lead-ins 84, 86 to the electrodes via the feedthroughs 20, 22 of the assembled arc discharge tube 10.

While there have been shown and described what are at present considered to be the preferred embodiments of the invention, it will be apparent to those skilled in the art that various changes and modifications can be made herein without departing from the scope of the invention as defined by the appended claims.

1. A method of making a fritless seal in a ceramic arc tube body comprising the steps of:
(a) inserting a feedthrough into an opening in a ceramic arc tube body, the feedthrough being comprised of niobium or a niobium alloy;
(b) heating the arc tube body to a first temperature in an inert gas to at least partially sinter the arc tube body, the inert gas being selected from the group of argon, neon, krypton, xenon and mixtures thereof; and
(c) further sintering the arc tube body by heating to a second temperature in a dry hydrogen atmosphere to form a hermetic seal between the feedthrough and the ceramic arc tube body, wherein the second temperature is higher than the first temperature.

2. The method of claim 1 wherein the ceramic arc tube body is comprised of polycrystalline alumina.

3. The method of claim 2 wherein the first temperature is from about 1000° C. to about 1400° C.

4. The method of claim 3 wherein the second temperature is from about 1800° C. to about 1850° C.

5. The method of claim 1 wherein prior to the insertion of the feedthrough the ceramic arc tube body has been first formed and treated by the steps of:
(i) molding a mixture of a ceramic material and a removable binder to form the arc tube body, the arc tube body including at least one opening progressing from the exterior of said body to an interior thereof;
(ii) firing the arc tube body at a lower temperature in air to partially remove the binder; and
(iii) pre-sintering the arc tube body at a higher temperature in air to complete the binder removal and strengthen the arc tube body.

6. The method of claim 5 wherein the ceramic material is alumina.

7. The method of claim 6 wherein the lower temperature is about 100° C. and the higher temperature is about 900° C.

8. A method of making a fritless seal in a ceramic arc tube body comprising the steps of:
(a) inserting a feedthrough into an one opening in a ceramic arc tube body, the feedthrough being comprised of niobium or a niobium alloy and the arc tube being comprised of polycrystalline alumina;
(b) heating the arc tube body to a first temperature in argon gas to at least partially sinter the arc tube body, and
(c) further sintering the arc tube body by heating to a second temperature in a dry hydrogen atmosphere to form a hermetic seal between the feedthrough and the ceramic arc tube body, wherein the second temperature is higher than the first temperature.

9. The method of claim 8 wherein step (b) further comprises increasing a furnace temperature from room temperature to the first temperature, wherein the first temperature is from about 1000° C. to about 1400° C., and step (c) further comprises increasing the furnace temperature from the first temperature to the second temperature, wherein the second temperature is from about 1800° C. to about 1850° C.

10. The method of claim 8 wherein the method further comprises the step of:
(d) allowing the ceramic arc tube body to cool in an argon atmosphere.

11. The method of claim 8 wherein the arc tube body has two openings for receiving feedthroughs and a feedthrough is sealed in each of the openings.

12. The method of claim 8 wherein the feedthrough is a niobium alloy containing up to about 2% zirconium by weight.

13. The method of claim 8 wherein the feedthroughs are thin-walled tubes.

14. The method of claim 11 wherein the feedthroughs are cup-shaped and one feedthrough has a closed end and the other feedthrough has a partially closed end having an aperture.

15. The method of claim 9 wherein the furnace temperature is increased at a rate of 15° C./min.

16. The method of claim 9 wherein the furnace temperature is held at the second temperature for about 2 hours to about 4 hours.

17. The method of claim 1 wherein the first temperature is from about 1350° C. to about 1400° C.

18. The method of claim 8 wherein the first temperature is from about 1350° C. to about 1400° C.

19. A method of making a fritless seal in a ceramic arc tube body comprising the steps of:
(a) inserting a feedthrough into an one opening in a ceramic arc tube body, the feedthrough being comprised of niobium or a niobium alloy and the arc tube being comprised of polycrystalline alumina;
(b) heating the arc tube body to about 1350° C. at a rate of about 15° C./min in argon gas to at least partially sinter the arc tube body; and
(c) further sintering the arc tube body by heating to about 1400° C. at a rate of about 15° C./min in a dry hydrogen atmosphere, holding at about 1400° C. for about 30 minutes in the dry hydrogen atmosphere, heating to about 1835° C. at a rate of about 15° C./min in the dry hydrogen atmosphere, holding at about 1835° C. for about 2 hours in the hydrogen atmosphere, to form a hermetic seal between the feedthrough and the ceramic arc tube body.
